(19) United States
(12) Patent Application Publication
(10) Pub. No.: US 2014/0062731 A1
(43) Pub. Date: Mar. 6, 2014

(54) BUS STOP SIGN AND SERVER CAPABLE OF PROVIDING DETAILED BUS SCHEDULES

(71) Applicants: TE-SHENG CHEN, New Taipei (TW); XIAO-GUANG LI, Shenzhen (CN); KUAN-HONG HSIEH, New Taipei (TW); YUN XIAO, Shenzhen (CN); SHANG-HUI PI, Shenzhen (CN); SHUANG RUI, Shenzhen (CN)

(72) Inventors: TE-SHENG CHEN, New Taipei (TW); XIAO-GUANG LI, Shenzhen (CN); KUAN-HONG HSIEH, New Taipei (TW); YUN XIAO, Shenzhen (CN); SHANG-HUI PI, Shenzhen (CN); SHUANG RUI, Shenzhen (CN)

(21) Appl. No.: 13/729,057

(22) Filed: Dec. 28, 2012

(30) Foreign Application Priority Data
Aug. 29, 2012 (CN) 2012103120275

(51) Int. Cl. G08G 1/127

(52) U.S. Cl. CPC G08G 1/127
USPC 340/993

(57) ABSTRACT

A bus stop sign capable of providing detailed bus schedules includes a storage unit, a detecting unit, a communicating unit, and a control unit. The storage unit pre-stores a table recording identifications of a plurality of mobile terminals, identifications of a plurality of bus terminals, and stop information of the bus stop sign along bus routes of the bus terminals. If the identifications of the mobile terminals obtained by the detecting unit match one or more identifications recorded in the table, the control unit obtains identifications of bus terminals recorded in the table corresponding to the obtained identifications, and controls the communicating unit to transmit the obtained identifications to the server. The server determines the current location of the nearest bus terminal travelling toward the bus stop sign and feeds back the current location of the nearest bus terminal to the mobile terminal. A related sever is also provided.

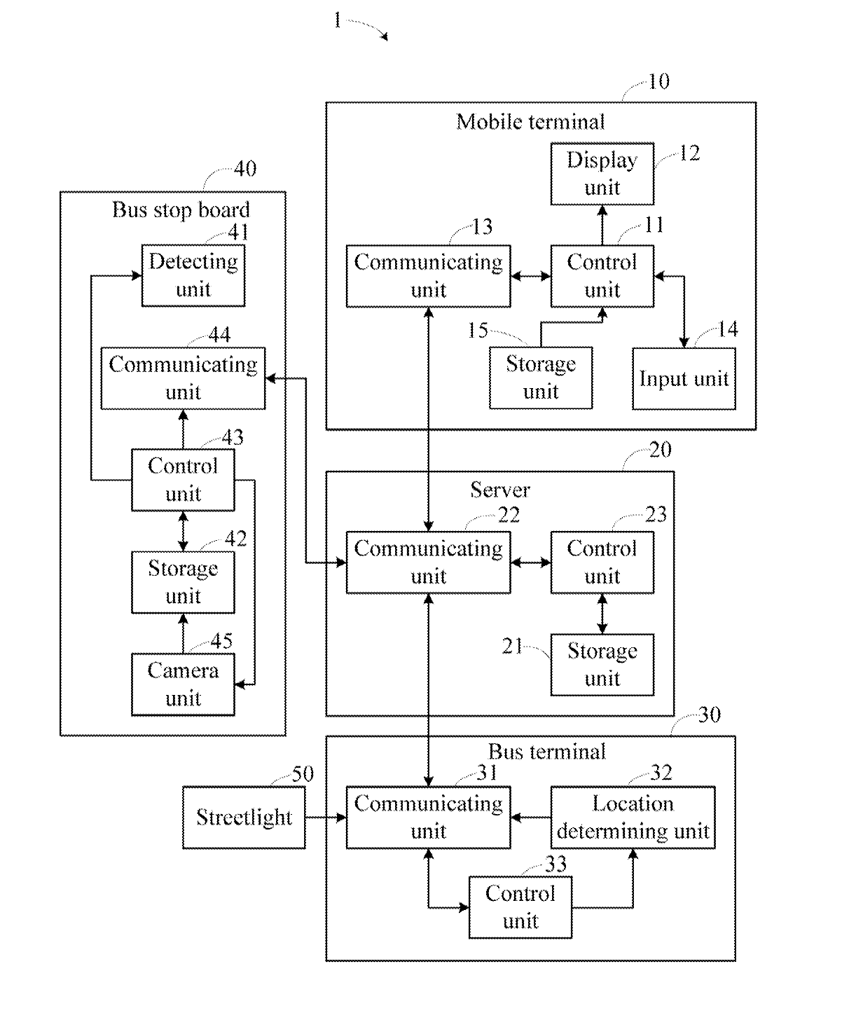

### BACKGROUND

1. Technical Field

The present disclosure relates to bus travelling monitoring systems and, particularly, to a bus stop sign and a server capable of providing detailed bus schedules.

2. Description of the Related Art

Traditional bus stop signs show only names of bus routes and names of stops along each bus route to passengers. However, the passengers cannot get arrival time of buses they want to take or traffic conditions of the route the buses are travelling, which results in the passengers waiting for the buses blindly, which is inconvenient for passengers, especially when the buses have broke down on the rode or are blocked in a traffic jam. Therefore, there is room for improvement within the art.

### BRIEF DESCRIPTION OF THE DRAWING

The emphasis is placed upon clearly illustrating the principles of the disclosure.

The figure is a diagram block of a system capable of providing detailed bus schedules, according to an exemplary embodiment.

### DETAILED DESCRIPTION

The figure shows a system 1 capable of providing detailed bus schedules. The system 1 includes a plurality of mobile terminals 10, a server 20, a plurality of bus terminals 30, and a plurality of bus stop signs 40. Each mobile terminal 10, such as a mobile phone, is taken along with a user and communicates with the server 20 via a network. Each of the plurality of bus stop signs 30 communicates with the server 20 and the other bus stop signs 40 via the network, such as via 3G wireless technology, General Packet Radio Service (GPRS), Code-Division Multiple Access (CDMA), Global System for Mobile communications (GSM), Zigbee, Zwave, IR, and NFC, for example. Each of the plurality of bus terminals 30 is employed in a bus (not shown), and each of the bus stop signs 40 stands at a bus stop.

Each bus terminal 30 includes a communicating unit 31, a location determining unit 32, and a control unit 33. The location determining unit 32 is configured for obtaining stop information of one or more bus stop signs 40 along the bus route within a predetermined range, and further determining a current location of the bus terminal 30 according to the obtained stop information. The stop information of each bus stop sign 40 includes a stop name and a location of the bus stop sign 40. The control unit 33 is configured for controlling the communicating unit 31 to transmit the current location of the bus terminal 30 determined by the location determining unit 32 and an identification of the bus terminal 30 to the server 20. In the embodiment, the identification of the bus terminal 30 includes data to record a corresponding route number of a bus route the bus terminal 30 takes. In addition, the identification of the bus terminal 30 includes data to record a number assigned to the bus terminal 30 when several bus terminals 30 correspond to the same route number, which means, several bus terminals 30 take the same route. In an alternative embodiment, the location determining unit 32 determines the current location of the bus terminal 30, and the control unit 33 controls the communicating unit 31 to transmit the current location of the bus terminal 30 to the server 20 after the predetermined time interval elapsed.

The server 20 includes a storage unit 21, a communicating unit 22, and a control unit 23. The storage unit 21 is configured for pre-storing a first table recording a plurality of identifications of the bus terminals 30, stop information of bus stop signs 40 along bus routes of the bus terminals 30, and the current locations of the bus terminals 30 correspondingly. The communicating unit 22 is configured for communicating with the plurality of bus terminals 30. When the server 20 receives the current location and the identification of a bus terminal 30 via the communicating unit 20, the control unit 23 is configured for updating the current location recorded in the first table corresponding to the identification of the bus terminal 30 with the received current location.

Each mobile terminal 10 includes a control unit 11, a display unit 12, a communicating unit 13, an input unit 14, and a storage unit 15. The communicating unit 13 is configured for communicating with the server 20. The storage unit 15 is configured for pre-storing an identification of the mobile terminal 10. In the embodiment, the mobile terminal 10 is a mobile phone, and the identification of the mobile terminal 10 is a telephone number. A user of the mobile terminal 10 inputs a name and a password for registration and authentication via the input unit 14. The display unit 12 is configured for displaying the user's name input by the input unit 14.

Each bus stop sign 40 includes a detecting unit 41, a storage unit 42, a control unit 43, and a communicating unit 44. The storage unit 42 is configured for pre-storing a second table recording a relationship among identifications of the plurality of mobile terminals 10, identifications of the bus terminals 30, and stop information of the bus stop signs 40 along bus routes of the bus terminals 30 correspondingly. In the embodiment, the relationship is pre-recorded according to a historical operation. In an alternative, the relationship is pre-set by the user. The detecting unit 41 is configured for detecting whether mobile terminals 10 appear within a predetermined range of the bus stop signs 40 and obtaining identifications of mobile terminals 10 those appear within the predetermined range. The control unit 43 is configured for determining whether the obtained identifications match one or more of the identifications recorded in the second table. When the obtained identification match one or more identifications recorded in the second table, the control unit 43 further obtains one or more identifications of the bus terminals 30 recorded in the second table corresponding to the obtained identifications of the mobile terminals 10. In addition, generates a request signal carrying the identifications of the bus terminals 30 and the identifications of the mobile terminal 10, and controls the communicating unit 44 to transmit the request signal to the server 20.

When the server 20 receives the request signal transmitted by the bus stop sign 40. The control unit 23 is configured for obtaining the identifications of the bus terminals 30 carried by the request signal. Furthermore, determines among those bus terminals 30, which one or ones are travelling toward the bus stop sign 40 according to the current locations of the bus terminals 30 and the location of the bus stop sign 40 according to the first table. The control unit 23 compares the current locations of the bus terminals 30 with the location of the bus stop sign 40 to determine the nearest bus terminal 30 to the bus stop sign 40. In addition, the control unit 23 evaluates a time the nearest bus terminal 30 is assumed to spend to reach the bus stop sign 40 from its current location, and controls the communicating unit 22 to transmit the current location of the nearest bus terminal 30 and/or the time evaluated to the mobile terminal 10.

In the embodiment, the detecting unit 41 detects the identifications of mobile terminals 10 at every predetermined time interval. The control unit 43 controls the communicating unit 44 to transmit a request signal carrying the identifications of bus terminals 30 corresponding to the detected identifications of mobile terminals to the server 20, to get the up-to-now current location of bus terminals for the mobile terminals. Therefore if a mobile terminal stays at the bus stop to wait for buses for a long time, it may receive updated current location of a corresponding bus terminal 30 continually.

In an alternative embodiment, the second table stored in the storage unit 42 further records favorable time periods of users to look up buses of particular bus routes corresponding to the identification of the bus terminals 30. For example, a registered user is used to take buses of route six to his office about 7 am to 8 am every workday. The registered users presets the period of 7 am to 8 am in every workday to be his favorable time period to look up buses of route six via the mobile terminal 30 of his or via the bus stop sign 40. The favorable time period 7 am to 8 am in every workday of the user is finally recorded in the second table stored in the storage unit 42. Therefore, each time the detecting unit 41 of the bus stop sign 40 detects that the identification of the mobile terminal 30 of the registered user appears, (the registered user appears on the bus stop). The control unit 43 determines whether the registered user appears in his favorite time period according to the second table. If yes, the control unit 43 automatically determines the identification of the bus terminal 30 the registered user looks up corresponding to his favorite time period according to the second table and delivers the identification of the bus terminal 30 to the server 20 utilizing the request signal.

The system 1 further includes a plurality of streetlights 50. Each of the plurality of streetlights 50 is in a pre-stored location. The location determining unit 32 determines the current location of the bus terminal 30 with reference to the location of nearby streetlights 50.

The bus stop sign 40 further includes a camera unit 45, mounted outside of the bus stop sign 40 for taking images surrounding the bus stop sign 40. The images are stored in the storage unit 42. The control unit 43 controls the communicating unit 44 to transmit the images taken by the camera unit 45 to the server 20, and store the images in the storage unit 21. The control unit 23 determines location of abnormal traffic information by analyzing the images transmitted by the plurality of bus stop signs 40, and further determines the bus routes passing the determined abnormal traffic location according to the first table. Upon a request being made by a mobile terminal 10 for a particular bus route, for example. A bus stop sign 40 detects a mobile terminal 10 and transmits a request signal for an expected bus route corresponding to the mobile terminal 10. The control unit 43 further determines whether any determined abnormal traffic location is on the expected bus route and feeds back the abnormal traffic location together with location of the nearest bus terminal 30 to the mobile terminal 10. The display unit 12 of the mobile terminal 10 displays the received the abnormal traffic location and the location of the nearest bus terminal 30. The user of the mobile terminal 10 thus knows the location of the nearest bus or buses on his or her expected route or routes and whether the nearest bus or buses are slowed down because of abnormal traffic information.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A server capable of providing detailed bus schedules comprising:
a storage unit configured for pre-storing a table recording a plurality of identifications of bus terminals, stop information of a plurality of bus stop signs along bus routes of the corresponding bus terminals, the storage unit configured for storing real-time locations of the bus terminals;
a communicating unit configured for communicating with the bus terminals, the bus stop signs, and a plurality of mobile terminals;
a control unit configured for:
receiving a request signal transmitted by and from a bus stop sign, the request signal carrying information of a location of the bus stop sign and an identification of one of mobile terminals;
determining one or more bus terminals which are travelling toward the bus stop sign according to the real-time locations of the bus terminals and the location of the bus stop sign;
comparing the real-time locations of the bus terminals with the location of the bus stop sign to determine the nearest bus terminal to the bus stop sign;
controlling the communicating unit to transmit the real-time location of the nearest bus terminal to the mobile terminal with the identification carried by the request signal.

2. The server capable of providing detailed bus schedules as claimed in claim 1, wherein the control unit is further configured for evaluating a time the nearest bus terminal is assumed to spend to reach the bus stop sign from its current location, and controlling the communicating unit to transmit the time evaluated to the mobile terminal.

3. The server capable of providing detailed bus schedules as claimed in claim 1, wherein the storage unit is further configured for storing images taken by the plurality of bus stop signs.

4. The server capable of providing detailed bus schedules as claimed in claim 3, wherein the control unit is further configured for determining a location of abnormal traffic information by analyzing the images transmitted by the plurality of bus stop signs, and controlling the communicating unit to transmit the abnormal traffic location and the location of the nearest bus terminal to the mobile terminal.

5. A bus stop sign comprising:
a storage unit configured for pre-storing a table recording a plurality of identifications of mobile terminals, a plurality of identifications of bus terminals, and stop information of the bus stop sign, each bus terminal configured to be mounted on a corresponding bus, bus routes of the bus terminals prestored in the table passing the bus stop sign, each mobile terminal being associated with one or more corresponding bus terminals, the stop information comprising a name and a location of the bus stop sign;
a detecting unit configured for detecting whether a mobile terminal appears within a predetermined distance range from the bus stop sign and obtaining the identification of the mobile terminal which appears;
a communicating unit configured for communicating with a server; and
a control unit configured for determining whether the obtained identification match an identification of a mobile terminal recorded in the table; and further configured for, if the obtained identification matches the identification of the mobile terminal recorded in the table, obtaining identifications of one or more bus terminals recorded in the table associated with the mobile terminal, generating a request signal carrying the identifications of the bus terminals and the identification of the mobile terminal, and controlling the communicating unit to transmit the request signal to the server for requesting the server to determine the real-time location of the nearest bus terminal travelling toward the bus stop sign and feed back the real-time location of the nearest bus terminal to the mobile terminal.

6. The bus stop sign as claimed in claim 5, further comprising a camera unit configured for capturing images of surrounding areas of the bus stop sign.

7. The bus stop sign as claimed in claim 6, wherein the control unit is further configured for controlling the communicating unit to transmit the images to the server for requesting the server to determine a location of abnormal traffic by analyzing the images transmitted by the plurality of bus stop signs, and feed back the abnormal traffic location and the location of the nearest bus terminal to the mobile terminal.

8. The bus stop sign as claimed in claim 5, wherein each mobile terminal is associated with one or more corresponding bus terminals according to a historical inquiry made by a user of said mobile terminal.

9. The bus stop sign as claimed in claim 5, wherein the detecting unit is configured to periodically detect a mobile terminal which appears within a predetermined distance range from the bus stop sign, the control unit is configured to control the communicating unit to transmit a request signal carrying the identifications of bus terminals associated with the detected mobile terminal to the server to update the real-time locations of the bus terminals associated with the detected mobile terminal.

10. The bus stop sign as claimed in claim 5, wherein the table further records time periods during which historical inquiries have been made by a user of said mobile terminal.
